(19) United States
(12) Patent Application Publication
(10) Pub. No.: US 2013/0250299 A1
(43) Pub. Date: Sep. 26, 2013

(54) METHODS OF CALIBRATING COLOR MEASUREMENT DEVICES

(71) Applicants: Yi-Lung WENG, Taoyuan County (TW); Tsun-Yi Wang, Taoyuan County (TW)

(72) Inventors: Yi-Lung WENG, Taoyuan County (TW); Tsun-Yi Wang, Taoyuan County (TW)

(73) Assignee: CHROMA ATE INC.

(21) Appl. No.: 13/424,386

(22) Filed: Mar. 20, 2012

(51) Int. Cl. G01J 3/50

(52) U.S. Cl. 356/402

(57) ABSTRACT

An embodiment of the invention provides a method of calibrating a color measurement device using a light source having a known color value. The color measurement device includes a light detector. The method includes: aligning the color measurement device and the light source so that the light source images on a center area of the light detector; deriving a detected color value for the light source based on the light detected by the center area when the light source images thereon; deriving a color calibration coefficient based on the detected color value and the known color value of the light source; and deriving a color and flat-field calibration array for the color measurement device by multiplying each entry of a flat-field calibration array of the color measurement device by the color calibration coefficient.

### BACKGROUND

1. Technical Field

The invention relates generally to color measurement devices, and more particularly, to methods of calibrating color measurement devices.

2. Related Art

A color measurement device can be used to measure the color of a light source, such as an illumination device or a display device. The light source's performance can then be determined based on the measurement result.

To ensure that the measurement result is accurate and reliable, the color measurement device must first be calibrated.

### BRIEF SUMMARY

An embodiment of the invention provides a method of calibrating a color measurement device using a light source having a known color value. The color measurement device includes a light detector. The method includes: aligning the color measurement device and the light source so that the light source images on a center area of the light detector; deriving a detected color value for the light source based on the light detected by the center area when the light source images thereon; deriving a color calibration coefficient based on the detected color value and the known color value of the light source; and deriving a color and flat-field calibration array for the color measurement device by multiplying each entry of a flat-field calibration array of the color measurement device by the color calibration coefficient.

Another embodiment of the invention provides a method of calibrating a color measurement device using a light source having a known color value. The color measurement device includes a light detector; the light detector includes a plurality of light detection regions. The method includes: aligning the color measurement device and the light source so that the light source images on the light detection regions; deriving a detected color value for each of the light detection regions based on the light detected by the light detection region when the light source images thereon; and deriving a color and flat-field calibration array for the color measurement device based on the detected color values corresponding to the light detection regions and the known color value of the light source.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings.

FIG. 1 shows a schematic diagram of a light detector of a color measurement device.

FIG. 2 shows a simplified flowchart of a method of calibrating the color measurement device.

FIG. 3 shows a simplified flowchart of another method of calibrating the color measurement device.

### DETAILED DESCRIPTION

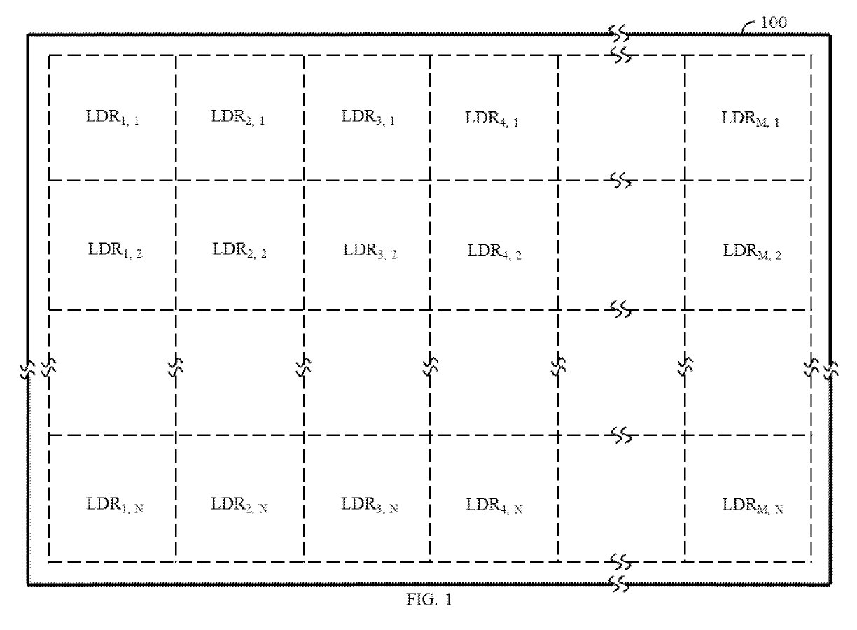

Generally speaking, a color measurement device has a light detector for detecting the light emitted by a light source. For example, the light detector can include a two dimensional charge-coupled device (CCD) and the light source can include a display device, an illumination device, or an array of display/illumination devices. FIG. 1 shows a schematic diagram of a light detector 100 of a color measurement device. As FIG. 1 indicates, the light detector 100 includes M×N light detection regions, where M and N are positive integers. Each of the light detection regions can have one or more pixels. In other words, the light detector 100 can have P×Q pixels, where P and Q are positive integers; the P×Q pixels can be divided into the M×N light detection regions, where M is not larger than P and N is not larger than Q. If a light detection region has more than one pixels, these pixels can share the same calibration coefficient(s) for color calibration, flat-field calibration, and/or color and flat-field calibration. With the M×N light detection regions' calibration coefficients, the P×Q pixels' calibration coefficients can be determined through extrapolation, interpolation, and/or normalization. The light detector 100 can be represented by the following set:

{LDR_{m, n}: m and n are positive integers, 1<=m<=M, and 1<=n<=N}

Based on the light emitted by a light source and detected by a light detection region LDR_{m, n}, the color measurement device can derive one or more detected color values. However, the detected color values may not be accurate because the spectral response of the color measurement device may not match that of an ideal model. For example, the ideal model can be the CIE 1931 color matching functions defined by the International Commission on Illumination (i.e. “CIE”) in 1931. Furthermore, the color measurement device may suffer from the so called vignetting effect. Because of these two reasons, the color measurement device must be calibrated before it's used to measure the color of a light source.

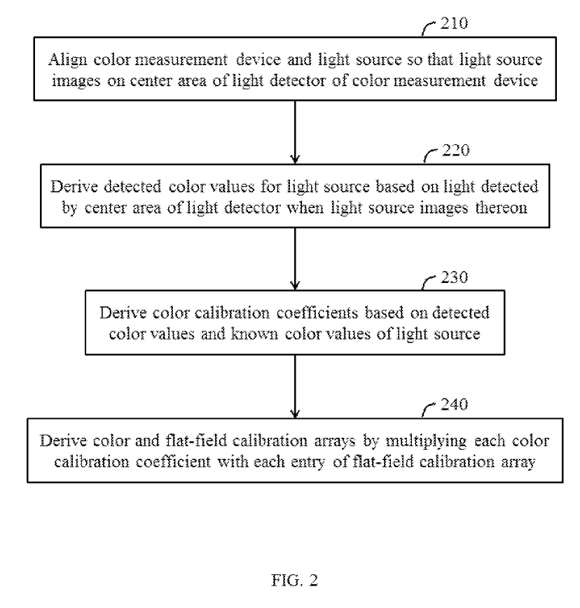

FIG. 2 shows a simplified flowchart of a method of calibrating the color measurement device. This method uses a light source with a known color value as a reference for calibration. For example, the light source can be a standard light source with known tristimulus values (i.e. known color values) Xₖ, Yₖ, and Zₖ in the CIE 1931 color space.

At step 210, the color measurement device and the light source are aligned so that the light source images on (i.e. projects an image onto) a center area of the light detector 100 of the color measurement device. The center area is an area within which the vignetting effect can be neglected; it may encompass one or more of the M×N light detection regions at or close to the center of the light detector 100. For example, the center area can be represented by the following set:

{LDR_{m, n}: m and n are integers, M₁<m<M₂, and N₁<n<N₂}

M₁ and M₂ are close to M/2, and N₁ and N₂ are close to N/2.

At step 220, detected color values are derived for the light source based on the light detected by the center area of the light detector 100 when the light source images on the center area. For example, these color values can include tristimulus values X_{d}, Y_{d}, and Z_{d} in the CIE 1931 color space.

Then, at step 230, color calibration coefficients are derived based on the detected color values and the known color values of the light source. For example, three color calibration coefficients can be derived based upon the following equations.

CCₓ=Xₖ/X_{d}

CC_{y}=Yₖ/Y_{d}

CC_{z}=Zₖ/Z_{d}

Before performing step 240, a flat-field calibration array must be determined for the color measurement device. The flat-field calibration array is an array that can offset the vignetting effect of the color measurement device. The flat-field calibration array can have one flat-field calibration for each of the M×N light detection regions, as follows.

$$FFCA = [ \begin{matrix}FFC ( 1 , 1 ) & … & FFC ( M , 1 ) \\ … & … & … \\ FFC ( 1 , N ) & … & FFC ( M , N )\end{matrix} ]$$

Theoretically, in the flat-field calibration array FFCA, the flat-field calibration coefficient FFC(m, n)=1 if M₁<m<M₂ and N₁<n<N₂. This is because, as mentioned above, the center area of the light detector 100 is an area within which the vignetting effect can be neglected. In other words, the light detected by the center area of the light detector 100 is not darker than it should be and hence need not be brightened by flat-field calibration coefficients FFC(m, n) larger than one. In contrast, the vignetting effect is detectable outside the center area. In other words, the light detected by the light detection regions outside the center area is darker than it should be and hence need to be brightened by flat-field calibration coefficients FFC(m, n) larger than 1. For example, because the vignetting effect is severest on the four light detection regions LDR_{1, 1}, LDR_{M, 1}, LDR_{1, N}, and LDR_{M, N} at the four corners of the light detector 100, the flat-field calibration coefficients FFC(1, 1), FFC(M, 1), FFC(1, N), and FFC(M, N) corresponding to these four light detection regions should be the largest coefficients in the flat-field calibration array FFCA.

At step 240, a color and flat-field calibration array is derived by multiplying each of the color calibration coefficients with each entry of the flat-field calibration array. Because in this example there are three color calibration coefficients, step 240 can derive three color and flat-field calibration arrays for the three tristimulus values, as follows.

$${CFFCA}_{x} = [ \begin{matrix}{CC}_{x} \times FFC ( 1 , 1 ) & … & {CC}_{x} \times FFC ( M , 1 ) \\ … & … & … \\ {CC}_{x} \times FFC ( 1 , N ) & … & {CC}_{x} \times FFC ( M , N )\end{matrix} ]$$

$${CFFCA}_{y} = [ \begin{matrix}{CC}_{y} \times FFC ( 1 , 1 ) & … & {CC}_{y} \times FFC ( M , 1 ) \\ … & … & … \\ {CC}_{y} \times FFC ( 1 , N ) & … & {CC}_{y} \times FFC ( M , N )\end{matrix} ]$$

$${CFFCA}_{z} = [ \begin{matrix}{CC}_{z} \times FFC ( 1 , 1 ) & … & {CC}_{z} \times FFC ( M , 1 ) \\ … & … & … \\ {CC}_{z} \times FFC ( 1 , N ) & … & {CC}_{z} \times FFC ( M , N )\end{matrix} ]$$

These three color and flat-field calibration arrays CFFCAₓ, CFFCA_{y}, and CFFCA_{z} can then be used to calibrate the color measurement device. For example, after step 240, the color measurement device can be used to measure the color of an array of light-emitting diodes (LEDs) defined by the following set:

{LED_{m, n}: m and n are positive integers, 1<m<M, and 1<n<N}

The array of LEDs and the color measurement device can be aligned so that for all m and n values, the LED_{m, n} images on (i.e. projects an image onto) the LDR_{m, n} of the light detector 100. Based on the light detected by the LDR_{m, n}, the color measurement device can derive uncorrected tristimulus values X_{uc}(m, n), Y_{uc}(m, n), and Z_{uc}(m, n) for the LED_{m, n}. Then, the color and flat-field calibration coefficients [CCₓ×FFC(m, n)], [CC_{y}×FFC(m, n)], and [CC_{z}×FFC(m, n)], in the arrays CFFCAₓ, CFFCA_{y}, CFFCA_{z}, can be used to calibrate the uncorrected tristimulus values X_{uc}(m, n), Y_{uc}(m, n), and Z_{uc}(m, n) to generate corrected tristimulus values X_{c}(m, n), Y_{c}(m, n), and Z_{c}(m, n) for the LED_{m, n}. Specifically:

X_{c}(m,n)=X_{uc}(m,n)×[CCₓ×FFC(m,n)]

Y_{c}(m,n)=Y_{uc}(m,n)×[CC_{y}×FFC(m,n)]

Z_{c}(m,n)=Z_{uc}(m,n)×[CC_{z}×FFC(m,n)]

The performance of the LED_{m, n} can then be correctly determined by comparing the expected tristimulus values Xₑ, Yₑ, and Zₑ of the LED_{m,n} with the corrected tristimulus values X_{c}(m, n), Y_{c}(m, n), and Z_{c}(m, n).

The calibration method shown in FIG. 2 is advantageous in that disregarding the measurement(s) required to determine the flat-field calibration array FFCA, the method requires only a single measurement of the know light source. As a result, the method is relatively simple and less time-consuming. Furthermore, because the single measurement is performed when the light source images on the center area of the light detector 100, the single measurement will be immune from the vignetting effect. In addition, for each tristimulus value (i.e. X, Y, or Z), a single color calibration coefficient (i.e. CCₓ, CC_{y}, or CC_{z}) is used for all the M×N light detection regions of the light detector 100. Therefore, the method may reduce the computation complexity and the volume of storage space required to store the calibration coefficients.

Although in the above paragraphs, three tristimulus values are calibrated, the aforementioned method can also be used to calibrate any number of tristimulus value(s) defined by the CIE 1931, or to calibrate any number of color value(s) defined by another color standard.

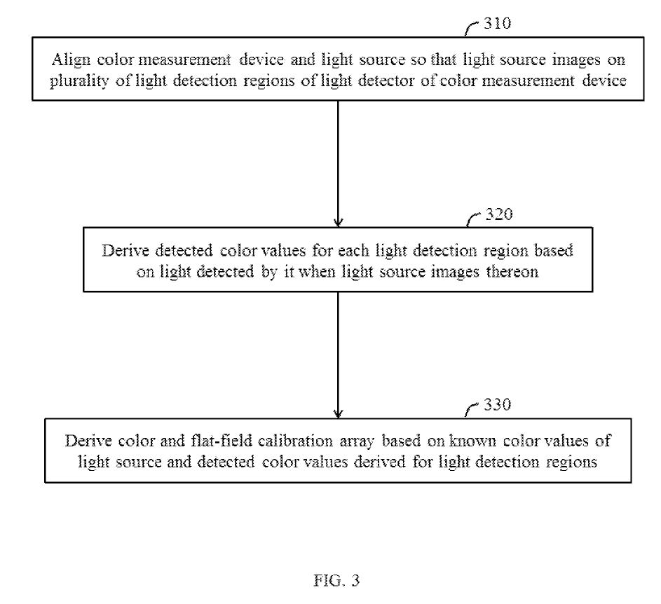

FIG. 3 shows a simplified flowchart of another method of calibrating the color measurement device. This method uses a light source with a known color value as a reference for calibration. For example, the light source can be a standard light source with known tristimulus values Xₖ, Yₖ, and Zₖ in the CIE 1931 color space.

At step 310, the color measurement device and the light source are aligned so that the light source images on the M×N light detection regions of the light detector 100. The light source can include M×N identical light source units so that within one alignment the M×N identical light source units can image on the M×N light detection regions, respectively. If the light source is not large and cannot image on all the M×N light detection regions within one alignment, the spatial relationship of the color measurement device and the light source can be changed at step 310 for several times so that the light source successively images on the M×N light detection regions of the light detector 100.

At step 320, detected color values are derived for each of the light detection regions based on the light detected by the light detection region when the light source images thereon. For example, for a light detection region LDR_{m, n}, a set of three tristimulus values X_{d}(m, n), Y_{d}(m, n), and Z_{d}(m, n) in the CIE 1931 color space can be derived based on the light detected by LDR_{m, n} when the light source images thereon. Because there are M×N light detection regions, step 320 can derive M×N sets of three tristimulus values.

Then, at step 330, a color and flat-field calibration array is derived based on the known color values of the light source and the detected color values corresponding to the M×N light detection regions. Specifically, at step 330, three color and flat-field calibration coefficients can be derived for each light detection region LDR_{m, n} based upon the following equations.

CFFCₓ(m,n)=Xₖ/X_{d}(m,n)

CFFC_{y}(m,n)=Yₖ/Y_{d}(m,n)

CFFC_{z}(m,n)=Zₖ/Z_{d}(m,n)

The color and flat-field calibration coefficients derived at step 330 can make up three color and flat-field calibration arrays CFFCAₓ, CFFCA_{y}, and CFFCA_{z}, as follows.

$${CFFCA}_{x} = [ \begin{matrix}{CFFC}_{x} ( 1 , 1 ) & … & {CFFC}_{x} ( M , 1 ) \\ … & … & … \\ {CFFC}_{x} ( 1 , N ) & … & {CFFC}_{x} ( M , N )\end{matrix} ]$$

$${CFFCA}_{y} = [ \begin{matrix}{CFFC}_{y} ( 1 , 1 ) & … & {CFFC}_{y} ( M , 1 ) \\ … & … & … \\ {CFFC}_{y} ( 1 , N ) & … & {CFFC}_{y} ( M , N )\end{matrix} ]$$

$${CFFCA}_{z} = [ \begin{matrix}{CFFC}_{z} ( 1 , 1 ) & … & {CFFC}_{z} ( M , 1 ) \\ … & … & … \\ {CFFC}_{z} ( 1 , N ) & … & {CFFC}_{z} ( M , N )\end{matrix} ]$$

These three color and flat-field calibration arrays CFFCAₓ, CFFCA_{y}, and CFFCA_{z} can then be used to calibrate the color measurement device. For example, after step 330, the color measurement device can be used to measure the color of an array of LEDs defined by the following set:

{LED_{m, n}: m and n are positive integers, 1<m<M, and 1<n<N}

The array of LEDs and the color measurement device can be aligned so that for all m and n values, the LED_{m, n} images on the LDR_{m, n} of the light detector 100. Based on the light detected by the LDR_{m, n}, the color measurement device can generate uncorrected tristimulus values X_{uc}(m, n), Y_{uc}(m, n), and Z_{uc}(m, n) for the LED_{m, n}. Then, the color and flat-field calibration coefficients CFFCₓ(m, n), CFFC_{y}(m, n), and CFFC_{z}(m, n) in the arrays CFFCAₓ, CFFCA_{y}, CFFCA_{z} can be used to calibrate the uncorrected tristimulus values X_{uc}(m, n), Y_{uc}(m, n), and Z_{uc}(m, n) to generate corrected tristimulus values X_{c}(m, n), Y_{c}(m, n), and Z_{c}(m, n). Specifically:

X_{c}(m,n)=X_{uc}(m,n)×CFFCₓ(m,n)

Y_{c}(m,n)=Y_{uc}(m,n)×CFFC_{y}(m,n)

Z_{c}(m,n)=Z_{uc}(m,n)×CFFC_{z}(m,n)

The performance of the LED_{m, n} can then be correctly determined by comparing the expected tristimulus values Xₑ, Yₑ, and Zₑ of the LED_{m, n} with the corrected tristimulus values X_{c}(m, n), Y_{c}(m, n), and Z_{c}(m, n).

Instead of requiring separate calibration processes for the color deviation and the vignetting effect, the method shown in FIG. 3 allows the color deviation and the vignetting effect to be calibrated together. There is no need to derive a color calibration array and a flat-field calibration array separately and then combine the color calibration array and the flat-field calibration array to derive a color and flat-field calibration array. Instead, the method shown in FIG. 3 derives the color and flat-field calibration arrays directly without first deriving intermediary color calibration arrays and flat-field calibration array separately. As a result, the method is relatively simple. Furthermore, the method may reduce the computation complexity and the volume of storage space required.

Although in FIG. 3 and the above paragraphs, three tristimulus values are calibrated, the aforementioned method can also be used to calibrate any number of tristimulus value(s) defined by the CIE 1931, or to calibrate any number of color value(s) defined by another color standard.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A method of calibrating a color measurement device using a light source having a known color value, the color measurement device comprising a light detector, the method comprising:
aligning the color measurement device and the light source so that the light source images on a center area of the light detector;
deriving a detected color value for the light source based on the light detected by the center area when the light source images thereon;
deriving a color calibration coefficient based on the detected color value and the known color value of the light source; and
deriving a color and flat-field calibration array for the color measurement device by multiplying each entry of a flat-field calibration array of the color measurement device by the color calibration coefficient.

2. The method of claim 1, wherein the step of deriving the color calibration coefficient comprises:
deriving the color calibration coefficient by dividing the known color value by the detected color value.

3. A method of calibrating a color measurement device using a light source having a known color value, the color measurement device comprising a light detector and the light detector comprising a plurality of light detection regions, the method comprising:
aligning the color measurement device and the light source so that the light source images on the light detection regions;
deriving a detected color value for each of the light detection regions based on the light detected by the light detection region when the light source images thereon; and
deriving a color and flat-field calibration array for the color measurement device based on the detected color values corresponding to the light detection regions and the known color value of the light source.

4. The method of claim 3, wherein the step of deriving the color and flat-field calibration array comprises:
for each of the light detection regions, deriving a color and flat-field calibration coefficient by dividing the known color value by a detected color value corresponding to the light detection region;
wherein a plurality of color and flat-field calibration coefficients derived for the light detection regions constitute the color and flat-field calibration array.
